(19) United States
(12) Patent Application Publication
(10) Pub. No.: US 2008/0106178 A1
(43) Pub. Date: May 8, 2008

(54) Method for making electrically conductive contact with and mechanically fixing a power supply element with a base element of a lamp and corresponding lamp

(75) Inventor: Roland Rittner, Heidenheim (DE)

Correspondence Address: Thomas Langer, Suite 1210, 551 Fifth Avenue, New York, NY, 10176, US

(73) Assignee: Patent-Treuhand-Gesellschaft fur elektrische Gluhlampen mbH, Munchen (DE)

(21) Appl. No.: 11/975,378

(22) Filed: Oct. 18, 2007

(30) Foreign Application Priority Data
Oct. 18, 2006 (DE) 10 2006 049 125.4

(51) Int. Cl. H01J 5/62; H01J 9/34

(52) U.S. Cl. 313/318.01; 445/27

(57) ABSTRACT

A method for making electrically conductive contact with and mechanically fixing a power supply element (12a) with a base element (10) of a lamp. The lamp comprises a luminous element (24), which is arranged within a closed luminous body (22) and can be connected to the power supply element (12a) so as to supply electrical energy. The base element (10) comprises at least one connection contact (28), by means of which the base element (10) can be connected to an electrical power source. The method comprises the steps of a) arranging at least one region (second end region 20) of the power supply element (12a) on an inner wall of the base element (10) and b) setting at least one weld point (18a, 18b) through an outer wall of the base element (10) onto the power supply element (12a), which is arranged on the inner wall, by means of a laser welding apparatus in such a way that electrically conductive contact is made between the power supply element (12a) and the base element (10) and said power supply element (12a) is fixed mechanically on said base element (10). Also disclosed is a lamp having a luminous element (24) arranged within a closed luminous body (22).

### FIELD OF THE INVENTION

The invention relates to a method for making electrically conductive contact with and mechanically fixing a power supply element with a base element of a lamp. The invention furthermore relates to a lamp having a luminous element arranged within a closed luminous body.

### BACKGROUND OF THE INVENTION

Method for making electrically conductive contact with and mechanically fixing a power supply element with a base element of a lamp can be found in the prior art as various embodiments which are known to a person skilled in the art. Such a power supply element is used for making electrically conductive contact between the luminous element, which is arranged within a closed luminous body, of the lamp and the base element. The base element forms, in addition to a conventionally used contact plate, the second electrical connection contact of the lamp. The power supply element itself is coupled to the luminous element and is usually guided through a gas-tight pinch seal of the lamp body. In order to make electrically conductive contact between the power supply element and the base element, the power supply element is, in a first step, welded to a fixing ring, which is fixed on the luminous body of the lamp, by means of resistance welding and mechanically fixed on it. In a second step, the mechanical fixing of the fixing ring and the base element then takes place by means of laser welding.

One disadvantage of this method and lamps having such a design can in this case be regarded as the fact that the process of making electrically conductive contact between the power supply element and the base element is complex and comparatively susceptible to faults, which often results in complaints.

### SUMMARY OF THE INVENTION

One object of the present invention is to provide a simpler and more reliable method for making electrically conductive contact between and mechanically fixing the power supply element and the base element.

A further object of the invention is to improve a generic lamp having a power supply element and a base element in such a way that it can be produced more easily, more quickly and more reliably.

These and other objects are attained in accordance with one aspect of the invention directed to a method for making electrically conductive contact with and mechanically fixing a power supply element with a base element of a lamp. The lamp has a luminous element, which is arranged within a closed luminous body and can be connected to the power supply element so as to supply electrical energy, and the base element comprises at least one connection contact, by means of which the base element can be connected to an electrical power source. The method comprises the steps of a.) arranging at least one region of the power supply element on an inner wall of the base element and b.) setting at least one weld point through an outer wall of the base element onto the power supply element, which is arranged on the inner wall, by means of a laser welding apparatus in such a way that electrically conductive contact is made between the power supply element and the base element and said power supply element is fixed mechanically on said base element.

In other words, provision is made according to an embodiment of the invention for welding to take place, by means of a laser welding apparatus, directly through the base element onto the power supply element and, as a result, for both the electrically conductive contact and the mechanical fixing to be provided. Owing to the fact that one of the two welding steps is dispensed with and as a result of the associated reduction in the possible sources of faults, the method can therefore be carried out more easily, more quickly and more reliably. Furthermore, owing to the fact that the welding step is dispensed with, a reduction in the production costs can be achieved. A further advantage consists in the fact that the use of the laser welding apparatus, in contrast to the prior art, allows for a concentrated injection of energy with comparatively low amounts of energy into the base element or the power supply element. As a result, for example, thermal distortion of the base element can be avoided which often occurs in the case of resistance welding owing to the high quantities of energy introduced into the workpieces. In addition to the reduced thermal loading, the mechanical forces acting on the components through welding tongs or the like are also no longer present, with the result that any impairment of the component geometries is avoided and largely tolerance-free assembly is possible. Since the laser beam, in contrast to the welding tongs, has an extremely low spatial requirement, by suitably adjusting the optics of the laser welding apparatus even geometrically complex base elements can be welded to sterically poorly accessible contact regions. A further advantageous aspect consists in a lesser tendency of the weld points to corrosion. Furthermore, the use of the laser welding apparatus allows for a considerably increased welding speed, with the result that the throughput of the production process can be additionally increased and further cost savings can be realized.

In order to be able to ensure electrically conductive contact-making and mechanical fixing which are as quick and reliable as possible, it has been shown to be advantageous for step b.) to comprise outputting a power of between 0.6 kW and 1.0 kW, preferably 0.8 kW, for a duration of between 8 ms and 12 ms, preferably 10 ms, and/or outputting a power of between 0.6 kW and 0.9 kW, preferably 0.7 kW, for a duration of between 18 ms and 22 ms, preferably 20 ms, onto a predetermined area of the outer wall of the base element in the region of the power supply element, which is arranged on the inner wall, by means of the laser welding apparatus. Owing to the mentioned welding parameters, when using conventional metals or metal alloys for the power supply element and the base element, the required welding depth is also ensured in a particularly simple manner. As is also disclosed in the context of the invention, however, it is necessary to take into consideration here the fact that the mentioned values are matched in a targeted manner to the properties of the respectively used materials.

A particularly high concentration of energy and therefore a rapid temperature rise over the melting point of the respective metal or the respective metal alloy of the power supply element and base element is achieved by virtue of the fact that the power of the laser welding apparatus is output in step b.) onto an area of between 0.25 mm² and 0.3 mm², preferably 0.28 mm². As a result, a diameter of a focal spot of the laser can be matched optimally to the respective material requirements and the respective geometric configuration of the base element. In addition, the material of the power supply element, which is arranged on the inside of the base element, is also melted on at points in a particularly rapid and undamaging manner.

In a further advantageous configuration of the invention, provision is made for, prior to step a.), a fixing ring with a substantially elongated depression to be fixed on the luminous body of the lamp, and at least regions of the power supply element to be arranged within the depression. Such a fixing ring, although it is not absolutely necessary, in contrast to the prior art, for carrying out the method according to the invention, firstly allows for a tip-proof arrangement of the base element and therefore increased mechanical stability. Secondly, the depression provided in the fixing ring, which depression is preferably arranged on a predetermined position of the fixing ring, represents a particularly simple and cost-effective means for the defined arrangement of the power supply element.

Particularly simple determination of the position of the power supply element, which is covered by the base element, and therefore defined setting of the at least one weld point can advantageously be ensured by virtue of the fact that the at least one weld point in step b.) is set on a region of the outer wall of the base element which lies in the region of that region of the power supply element which is arranged within the depression of the fixing ring.

In order to be able to ensure particularly reliable electrically conductive contact-making and mechanical fixing, it has proven advantageous for step b.) to comprise setting of a plurality of weld points. This also makes it possible to adapt, in a simple manner, to different configurations in terms of material and geometry of the power supply element and the base element, with the result that, for example, in the case of small or light base elements, one weld point can be set and, in the case of large or heavy base elements, on the other hand, a plurality of weld points can be set.

A further aspect of the invention relates to a lamp having a luminous element, which is arranged within a closed luminous body and in which provision is made according to the invention for the power supply element to be mechanically fixed on an inner wall of the base element and electrically conductive contact to be made between said power supply element and the base element, the mechanical fixing and the electrically conductive contact-making being brought about by welding by means of a laser welding apparatus. In other words, provision is accordingly made, in contrast to the prior art, for the power supply element and the base element to be welded directly to one another and for in this case the welding to be brought about with the aid of a laser welding apparatus instead of by means of a resistance welding apparatus. The lamp can therefore be produced more easily, more quickly and more reliably since both the contact-making and the fixing do not take place indirectly via a fixing ring and two resistance weld points, as is known from the prior art, but via direct laser welding. In addition, this is firstly made possible by the novel use of the laser welding apparatus since welding of the power supply element to the inner wall of the base element by means of resistance welding is not possible, or is only possible with a high degree of technical complexity. The welding by means of the laser welding apparatus also ensures, owing to the high welding speed, the simple automatability for example by means of computerized numerical controllers (CNC) and the avoidance of thermal distortion of the workpieces, additional savings in terms of time and costs.

In an advantageous configuration of the invention, provision is made for the welding to be brought about by means of an Nd:YAG laser. Nd:YAG lasers, which use a neodymium-doped yttrium aluminum garnet crystal with a wavelength of approximately 1.06 μm as the active medium, in this case provide the advantage that the laser beam produced is capable of being transmitted by optical fibers and can be guided particularly easily via corresponding optical waveguides into the laser welding optics. In principle, however, further suitable types of lasers such as CO₂ lasers or the like, for example, can also be provided.

In a further advantageous configuration of the invention, provision is made for the power supply element to be electrically conductively coupled to the connection contact of the base element. As a result, the luminous element, which is coupled to the power supply element, can be supplied the electrical energy from the electrical power source in a particularly simple and reliable manner. In a particularly simple manner, the electrically conductive coupling can be achieved by virtue of the fact that the connection contact and the base element are designed to be integral, and the inner wall of the base element is therefore electrically conductively coupled to the connection contact.

In a further advantageous configuration of the invention, a fixing ring is provided which is fixed on the luminous body and comprises a substantially elongated depression, within which at least regions of the power supply element are arranged for alignment purposes. Such a fixing ring firstly ensures a particularly mechanically stable configuration of the lamp since it prevents the base element from tipping to the side. In addition, the laser welding apparatus can be positioned in a particularly simple manner owing to the defined position of the power supply element in the depression.

In a further advantageous configuration of the invention, provision is made for the lamp to be in the form of a low-volt and/or medium-volt and/or high-volt halogen lamp. With these lamp types, particularly significant savings can be achieved as a result of the previously described advantages in terms of time and costs owing to the high numbers in which they are produced. However, it should be stressed that the invention should not be regarded as being restricted to these lamp types and that no restrictive limitations as regards the type of lamp should be placed on a person skilled in the art.

### BRIEF DESCRIPTION OF THE DRAWINGS

Further advantages, features and details of the invention are given in the description below relating to a preferred exemplary embodiment and with reference to the drawing, in which identical or functionally identical elements have been provided with the same reference symbols and in which:

FIG. 1 shows a schematic sectional view from above of a power supply element, which has been welded to a base element of a lamp and is arranged in a depression of a fixing ring;

FIG. 2 shows an enlargement of the detail I shown in FIG. 1 along the section line II-II, in a schematic side view;

FIG. 3 shows a schematic side view of a further exemplary embodiment of the lamp, before the base element has been arranged on the power supply element; and

FIG. 4 shows a schematic side view of the lamp shown in FIG. 3, the base element being arranged on the power supply element and being welded to it by means of a laser welding apparatus.

### DETAILED DESCRIPTION OF THE DRAWINGS

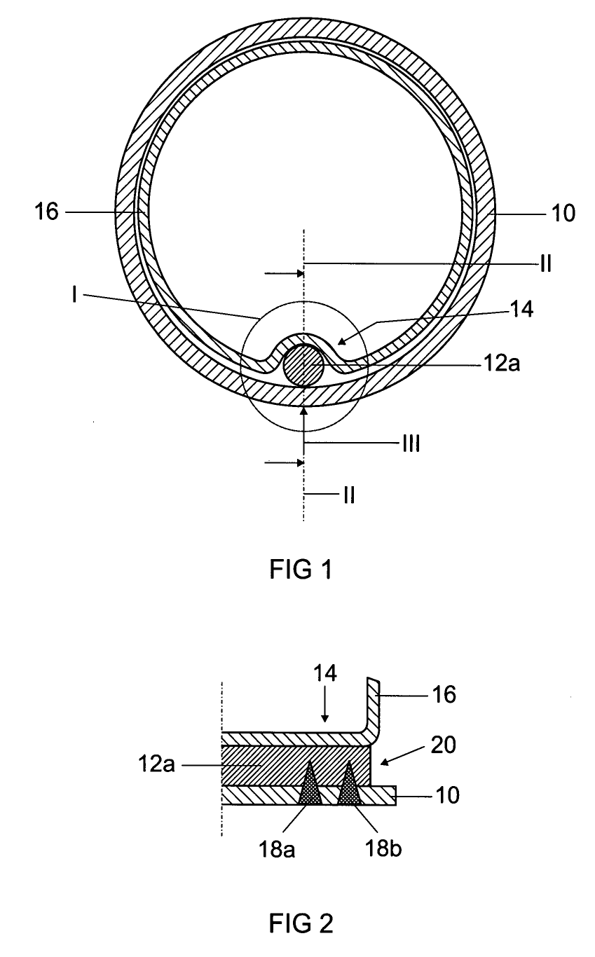

FIG. 1 depicts a schematic sectional view from above of a power supply element 12a, which has been welded to a base element 10 of a lamp and is arranged in a depression 14 of a fixing ring 16. During fitting of this lamp, in this case first the fixing ring 16 was fixed on a gas-tight luminous body (not depicted) of a lamp. Then, regions of the power supply element 12a, which is guided within the fixing ring 16 out of the lamp body, is electrically conductively coupled to a luminous element of the lamp at a first end region (not depicted) and is in this case in the form of a cable wire, are bent back, and a second end region 20 (see FIG. 2) of said power supply element 12a is arranged within the depression 14 of the fixing ring 16. Here, the depression 14 is in this case designed to be elongate and is provided with an inner contour, which substantially corresponds to an outer contour of the power supply element 12a. In this context, different configurations of the depression of the fixing ring 16 such as inner contours which are prismatic or square in cross section, for example, are also conceivable. However, it should be stressed that neither the fixing ring 16 nor the depression 14 are required for carrying out the method according to the invention or for producing the lamp according to the invention.

Then, the base element 10, which in this case is round in cross section and is designed to correspond to an outer contour region of the fixing ring 16, is plugged onto the fixing ring 16 flush in such a way that the second end region 20 of the power supply element 12a bears against the inner wall of the base element 10. By setting two weld points 18a, 18b (see FIG. 2) as shown by the arrow III by means of a laser welding apparatus (not illustrated), finally electrically conductive contact is made between the base element 10 and the power supply element 12a and they are fixed mechanically to one another.

FIG. 2 depicts an enlargement of the detail I shown in FIG. 1 along the section line II-II, in a schematic side view. It can be seen in particular here that the two weld points 18a, 18b are set next to one another by means of the laser welding apparatus through the outer wall of the base element 10 onto the second end region 20 of the power supply element 12a. Simultaneously setting two weld points 18a, 18b in one welding step and therefore particularly reliable and quick contact-making and fixing can advantageously be achieved by using a laser with bifocal optics, since the bifocal optics produce two focal spots next to one another. It is also conceivable here for only one or more weld points to be set on different regions of the power supply element 12a at different distances from one another. The determination of the position of the power supply element 12a which is covered by the base element 10, which determination is required for welding purposes, can in this case take place in a particularly simple manner by rotating the luminous body of the lamp, since the position of the power supply element 12a, which is coupled to the luminous element, is also determined by the position of the luminous element with respect to the fixing ring 16. Alternatively, image recognition for controlling the laser beam can also be used. The use of the laser welding apparatus furthermore also makes it possible to subsequently make electrically conductive contact between and mechanically fix the power supply element and the base element. This also makes it suitable as a replacement for known soldering processes, with the result that, in addition to the previously described advantages such as increased speed, more cost-effective production, reduced thermal distortion and lesser tendency to corrosion of the contact points, the existing problems such as excessive solder residues or chemically aggressive flux can also be avoided.

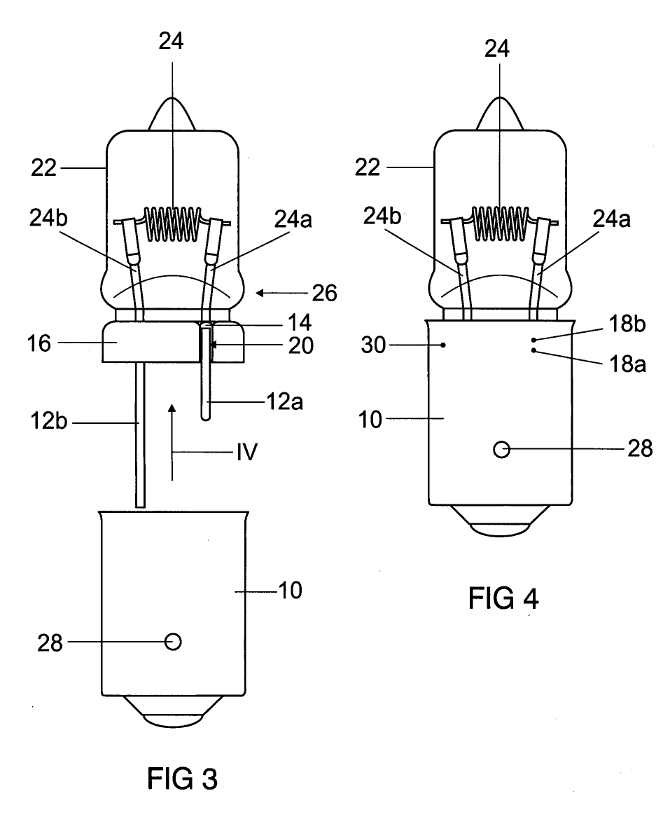

For further clarification purposes, FIG. 3 depicts a schematic side view of a further exemplary embodiment of the lamp, before the base element 10 is arranged on the power supply element 12. This figure shows the luminous element 24, which is arranged within the closed luminous body 22 and in the present case is in the form of an incandescent filament. The luminous element 24 is guided with its two end regions 24a, 24b through a pinch seal 26 of the luminous body 22. The two end regions 24a, 24b are each coupled to their corresponding power supply element 12a, 12b within the pinch seal. The power supply element 12a is guided in the inner region of the fixing ring 16 out of the lamp body 22 and bent with its end region 20 into the depression 14. The power supply element 12b is not bent and can be coupled in a subsequent fitting step to a contact plate or the like of the lamp. In order to carry out the method, the base element 10, which has a substantially cylindrical connection contact 28 for connection to an electrical power source on its lower region, is pushed onto the fixing ring 16 along the arrow IV, as a result of which the second end region 20 of the power supply element 12 bears against the inner wall of the base element 10.

FIG. 4 shows, in a schematic side view, the lamp shown in FIG. 3, the base element 10 being arranged on the power supply element 12 and being welded to said power supply element 12 by means of a laser welding apparatus at the weld points 18a, 18b. Since the power supply element 12 is coupled to the luminous element 24 via its end region 24a, its position can also be determined when the power supply element 12 is covered by the base element 10. It is particularly preferable here that the inner wall of the base element 10 and therefore the power supply element 12 itself is electrically conductively connected to the connection contact 28. In the present exemplary embodiment, the base element 10 is welded to the fixing ring 16 via a further weld point 30 in order to ensure additional mechanical stabilization of the connection between the luminous body 22 and the base element 10. In this case it is also conceivable to set further stabilizing weld points.

1. A method for making electrically conductive contact with and mechanically fixing a power supply element with a base element of a lamp, the lamp comprising a luminous element, which is arranged within a closed luminous body and can be connected to the power supply element so as to supply electrical energy, and the base element comprising at least one connection contact, by means of which the base element can be connected to an electrical power source, wherein the method comprises the steps of:
a.) arranging at least one region of the power supply element on an inner wall of the base element; and
b.) setting at least one weld point through an outer wall of the base element onto the power supply element, which is arranged on the inner wall, by means of a laser welding apparatus in such a way that electrically conductive contact is made between the power supply element and the base element and said power supply element is fixed mechanically on said base element.

2. The method as claimed in claim 1, wherein step b.) comprises outputting a power of between 0.6 kW and 1.0 kW, preferably 0.8 kW, for a duration of between 8 ms and 12 ms, preferably 10 ms, and/or outputting a power of between 0.6 kW and 0.9 kW, preferably 0.7 kW, for a duration of between 18 ms and 22 ms, preferably 20 ms, onto a predetermined area of the outer wall of the base element in the region of the power supply element, which is arranged on the inner wall, by means of the laser welding apparatus.

3. The method as claimed in claim 1, wherein the power of the laser welding apparatus is output in step b.) onto an area of between 0.25 mm² and 0.3 mm².

4. The method as claimed in claim 1, wherein, prior to step a.), a fixing ring with a substantially elongated depression is fixed on the luminous body of the lamp, and at least regions of the power supply element are arranged within the depression.

5. The method as claimed in claim 4, wherein the at least one weld point in step b.) is set on a region of the outer wall of the base element which lies in the region of that region of the power supply element which is arranged within the depression of the fixing ring.

6. The method as claimed in claim 1, wherein step b.) comprises setting a plurality of weld points.

7. A lamp having a luminous element, which is arranged within a closed luminous body and is coupled to a power supply element for the purpose of supplying electrical energy, and having a base element, which comprises at least one connection contact for making detachable electrical contact between the base element and an electrical power source, wherein the power supply element is mechanically fixed on an inner wall of the base element, and electrically conductive contact is made between said power supply element and the base element, the mechanical fixing and the electrically conductive contact-making being brought about by welding by means of a laser welding apparatus.

8. The lamp as claimed in claim 7, wherein the welding is brought about by means of an Nd:YAG laser.

9. The lamp as claimed in claim 7, wherein the power supply element is electrically conductively coupled to the connection contact of the base element.

10. The lamp as claimed in claim 7, wherein a fixing ring is provided which is fixed on the luminous body and comprises a substantially elongated depression, within which at least regions of the power supply element are arranged for alignment purposes.

11. The lamp as claimed in claim 7, wherein the lamp is in the form of a low-volt and/or medium-volt and/or high-volt halogen lamp.

12. The lamp as claimed in claim 3, wherein the power of the welding apparatus is output in step b.) onto an area of 0.28 mm².
